(19) United States
(12) Patent Application Publication
(10) Pub. No.: US 2003/0200685 A1
(43) Pub. Date: Oct. 30, 2003

(54) Tensioning system for signs

(76) Inventor: John D. Gibb, Duluth, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 10/360,542

(22) Filed: Feb. 6, 2003

Related U.S. Application Data
(60) Provisional application No. 60/354,889, filed on Feb. 6, 2002.

(51) Int. Cl. G09F 17/00; G09F 15/00

(52) U.S. Cl. 40/603; 40/624

(57) ABSTRACT

A tensioning system for a sign mounted to frame, such as a billboard sign. A single tensioning cable is provided, having a plurality of movable hooks positioned at various intervals therealong. The cable is confined by pulleys attached to the frame and extends along one horizontal portion of the frame, then along one vertical portion of the frame, to one or more tensioning winches. The movable hooks are engaged with the rods along a corresponding horizontal and vertical edge of the sign. The opposite horizontal and vertical edges of the sign are affixed by stationary or fixed hooks to the frame. By tightening the cable with the tensioning winch or winches, the cable is pulled taut along the one horizontal and one vertical edge of the sign. There is no need for separate tensioning belts and devices, which are replaced by a single tensioning cable.

### CROSS-REFERENCE TO RELATED APPLICATION

This application claims priority to U.S. patent application Ser. No. 60/354,889, filed Feb. 6, 2002, which is incorporated in its entirety by reference and made a part hereof.

### TECHNICAL FIELD

The present invention relates generally to flexible signs such as billboards, and more particularly relates to a tensioning system for flexible signs.

### BACKGROUND

Flexibly vinyl signs are known in the art. Theses signs are typically large rectangular sheets of vinyl material on which text, images, and other indicia are printed or painted. The signs are then typically suspended or supported in a generally rectangular frame. Because the signs are flexible, they must be mounted to the frame under tension so as to withstand forces such as wind and rain, yet be readily transportable to a remote sign site and be readily replaceable by new signage when needed.

One known method for supporting a flexible sign is to provide a plurality of tensioning belts with ratchet mechanisms along the horizontal and vertical edges of the sign. A hook is mounted to one end of the tensioning belt; the other end is fastened to the sign frame. The hook is affixed to a rod that is attached to and running along a lateral edge of the flexible sign. The ratchet mechanism is then used to apply tension to the belt and pull the rod and sign taut relative to the sign frame. Another known method is to utilize a plurality of turnbuckle-type fasteners with threaded rods and eye bolts. However, it is time consuming and expensive to install and tension a plurality of separate belts and ratchet mechanisms or turnbuckle-type fasteners. There is a need for a more efficient way to tension a flexible sign.

### SUMMARY OF THE INVENTION

According to the present invention, a single point tensioning system is provided, which obviates a plurality of separate tensioning belts or turnbuckles. A single tensioning cable is provided, having a plurality of movable hooks positioned at various intervals therealong. The cable is confined by pulleys attached to the frame and extends along one horizontal portion of the frame, then along one vertical portion of the frame, to a tensioning winch. The movable hooks are engaged with the rods along a corresponding horizontal and vertical edge of the sign. The opposite horizontal and vertical edges of the sign are affixed by stationary or fixed hooks to the frame. By tightening the cable with the tensioning winch, the cable is pulled taut along the one horizontal and one vertical edge of the sign. There is no need for separate tensioning belts and devices, which are replaced by a single tensioning cable that is fixed at a single point, i.e. at the tensioning winch.

These and other features and advantages of the invention may be more clearly understood and appreciated from a review of the following detailed description of the disclosed embodiments, and by reference to the appended drawings and claims.

### BRIEF DESCRIPTION OF THE DRAWING FIGURES

FIG. 1 illustrates a sign tensioning system constructed in accordance with a first preferred embodiment of the invention, with a single winch or single tensioning point.

FIG. 2, consisting of FIG. 2A and FIG. 2B, shows a pulley type hook arrangement in the disclosed embodiment.

FIG. 3 illustrates a hook type fastening arrangement that is alternative and legally equivalent to a pulley type hook fastening arrangement.

FIG. 4 illustrates details of idler pulleys with a movable hook and movable pulley, and a direction-changing pulley.

FIG. 5 illustrates a side edge of a frame with pulleys and hooks engaged in a tensioned sign.

FIG. 6 illustrates a tensioning winch, direction-changing pulleys, and a topmost movable hook and pulley.

FIG. 7 illustrates an endmost moveable hook in an untensioned mode of a sign.

FIG. 8 illustrates a portion of an alternative embodiment of a tensioning system that employs a multiple tensioning arrangement.

FIG. 9 illustrates a closer view of a winch tensioning device in the alternative embodiment.

FIG. 10 illustrates a closer view of a winch tensioning device in the alternative embodiment.

FIG. 11 illustrates a closer view of a winch tensioning device in the alternative embodiment.

FIG. 12 illustrates in detail the alternative embodiment of a tensioning system that employs a multiple tensioning arrangement.

### DETAILED DESCRIPTION OF THE DISCLOSED EMBODIMENTS

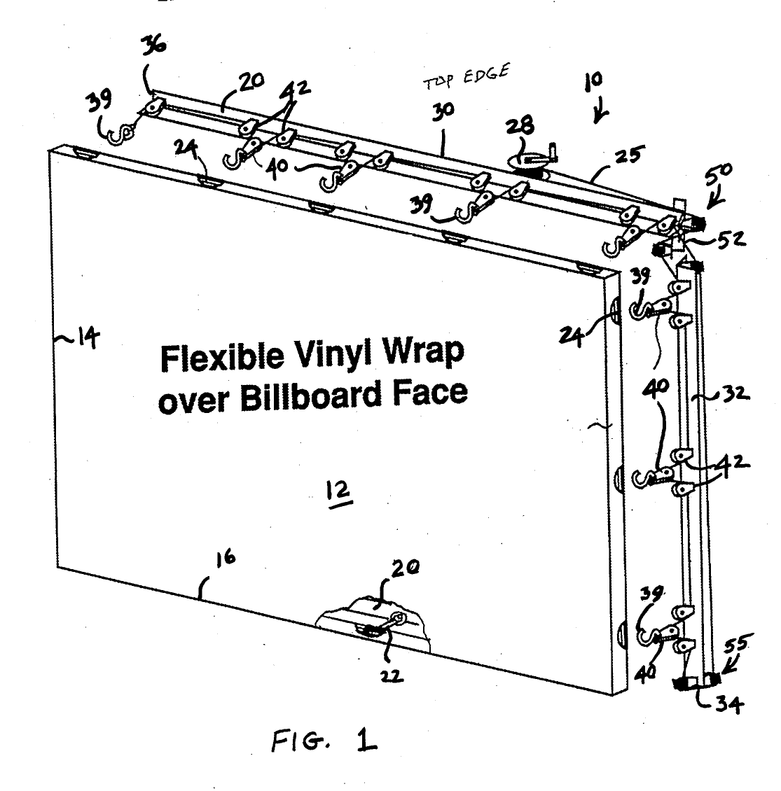

FIG. 1 illustrates a first embodiment of a tensioning system 10 according to a preferred embodiment of the invention, having a single tensioning point. The flexible vinyl sign 12 is affixed along one horizontal edge 14 to a sign frame 20, and along one vertical edge 16 to the sign frame. The edges 14, 16 are affixed to the frame by stationary hooks 22 that are engaged with rods 24 extending along the respective horizontal edge 14 and vertical edge 16 of the sign 12. The rods 24 are attached to the edges of the sign 12 by wrapping a portion of the vinyl material and bonding the material to itself by heat sealing, glue, stitching, or the like, and exposing the rod by cutting or slitting the vinyl material.

The tensioning system 10 according to this aspect comprises a single elongate cable 25 that extends along the frame 20 from a fixed point at a tensioning winch 28, along the top edge 30 of the frame, down a vertical edge 32 of the frame to a bottom point 34, upwardly along the vertical edge 32, and then along the top edge 30 of the frame to the far-most terminating point 36.

A plurality of moveable tensioning hooks 39 are provided on movable pulleys 40 positioned at intervals along the cable 25. The moveable tensioning hooks 39 engage the rods on the flexible sign 12 on edges of the sign opposite the fixed horizontal edge 14 and fixed vertical edge 16. The movable hooks 39 and pulleys 40 are preferably suspended between a pair of idler pulleys or rollers 42, so as to keep the movable hooks and pulleys generally in position.

In the first exemplary embodiment, a set of direction-changing pulleys 50 are provided at the comer 52 of the frame to direct the cable 25 from a horizontal run from the winch 28 to a downward run along the vertical frame edge 32. A second set of direction-changing pulleys 55 is provided at the bottom point 34 of the frame 20, to change the direction of the cable from downwardly extending to upwardly extending.

The sign 12 is installed in the frame 20 by engaging the movable hooks 39 with the exposed rods 24 along the top edge of the sign and a vertical edge of the sign, then attaching the fixed hooks 22 to the bottom edge and opposite side (vertical) edge, and then tensioning the entire sign by taking up slack in the cable 25 with the winch 28.

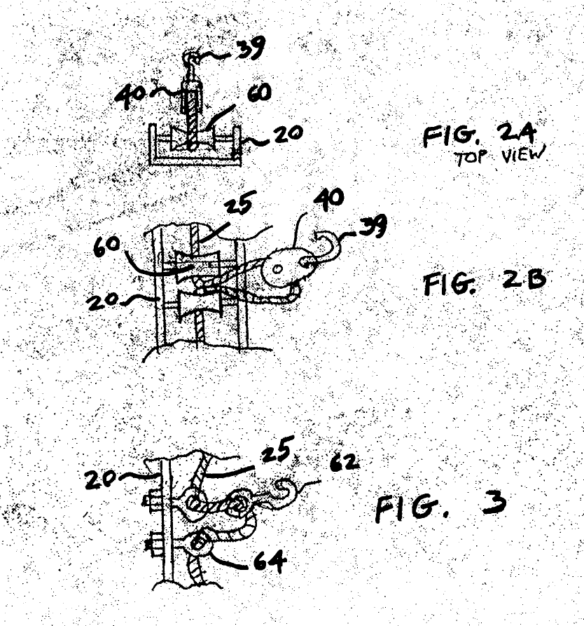

Although the preferred embodiment utilizes a system of pulleys to minimize friction when the sign is tensioned, it will be appreciated that other configurations may be utilized, for example, the fixed pulleys 42 could be replaced with rollers 60 mounted to the frame 20 (FIG. 2A and 2B), the movable hook 39 could be replaced with a hook-and-eye 62 (FIG. 3), and the cable 25 could be run through adjacent eye bolts 64 mounted to the frame 20 (FIG. 3). Such configurations, although operable, may not be as optimal in terms of friction and tension, but should be operative, and perhaps less expensive in terms of components.

FIG. 4 illustrates details of a pair of idler pulleys 42, with a movable hook 39 and movable pulley 40, and the direction-changing pulley set 55.

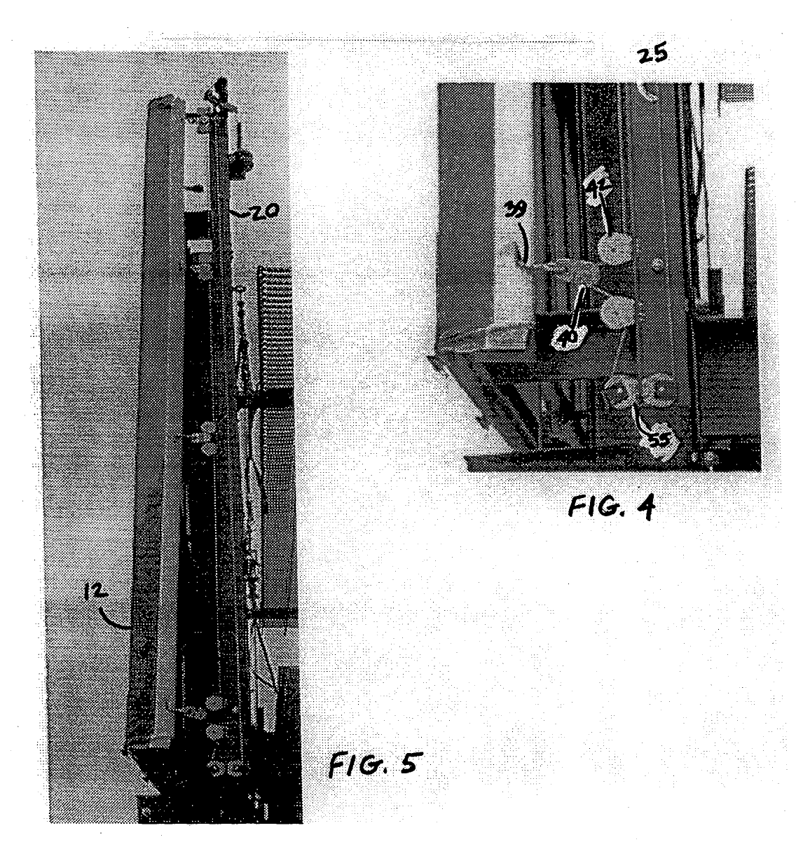

FIG. 5 illustrates the side edge of the frame 20, with pulleys and hooks engaged in a tensioned sign 12.

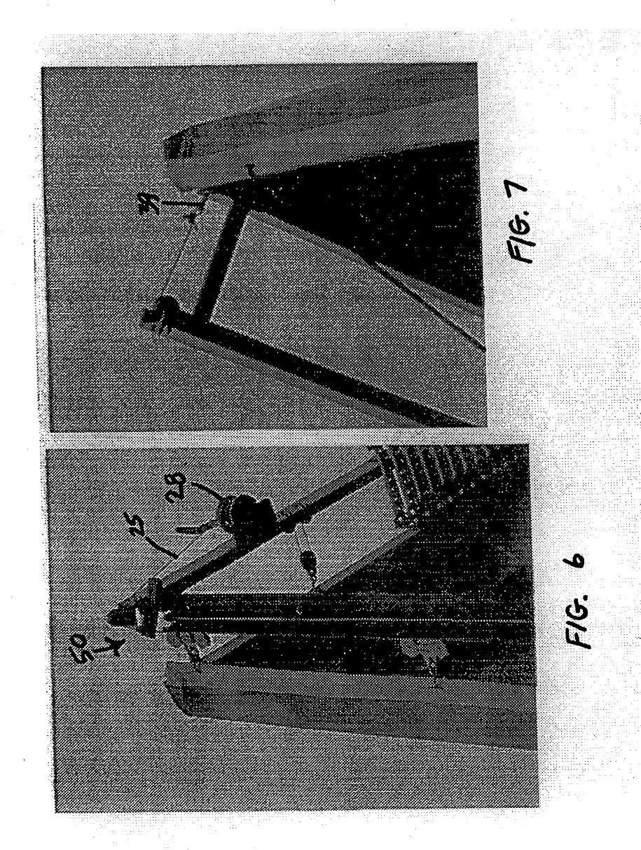

FIG. 6 illustrates the tensioning winch 28, direction-changing pulleys 40, and a topmost movable hook and pulley.

FIG. 7 illustrates the endmost moveable hook 39 in an untensioned mode of a sign 12.

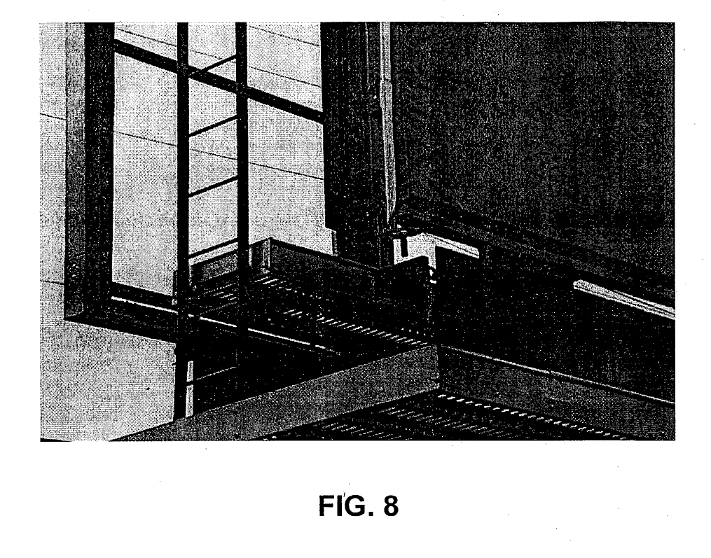

FIG. 8 illustrates a portion of an alternative embodiment 10′ of a tensioning system that employs a multiple tensioning arrangement with a winch 28a one end of the cable 25 and a second winch 28b at the other, opposite end of the cable.

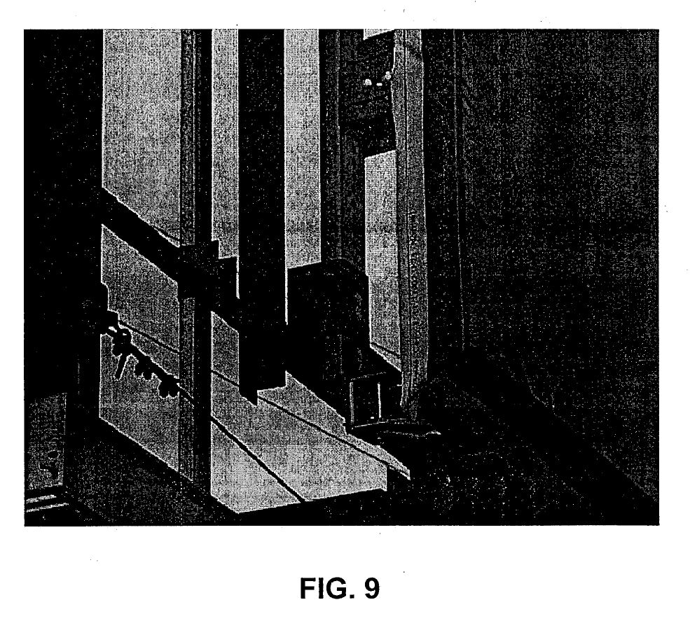

FIG. 9 illustrates a closer view of a winch tensioning device 28a, 28b in the alternative embodiment.

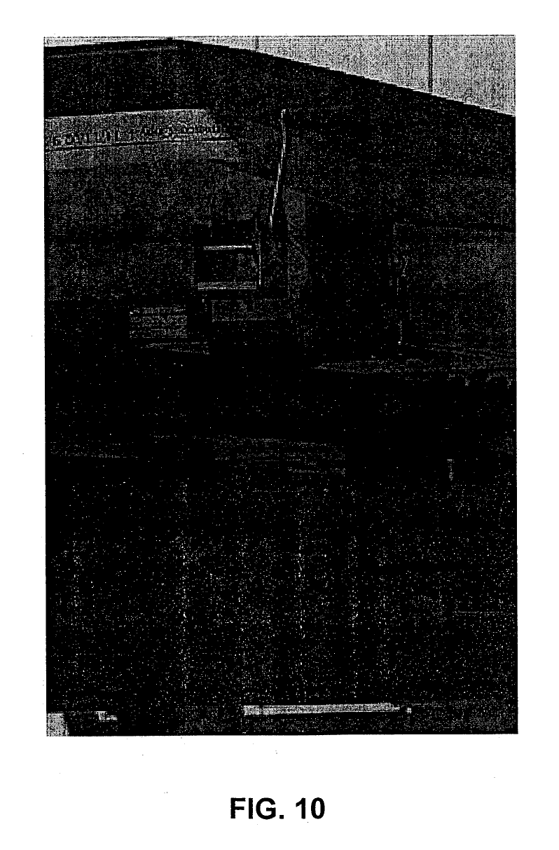

FIG. 10 illustrates a closer view of a winch tensioning device 28a, 28b in the alternative embodiment.

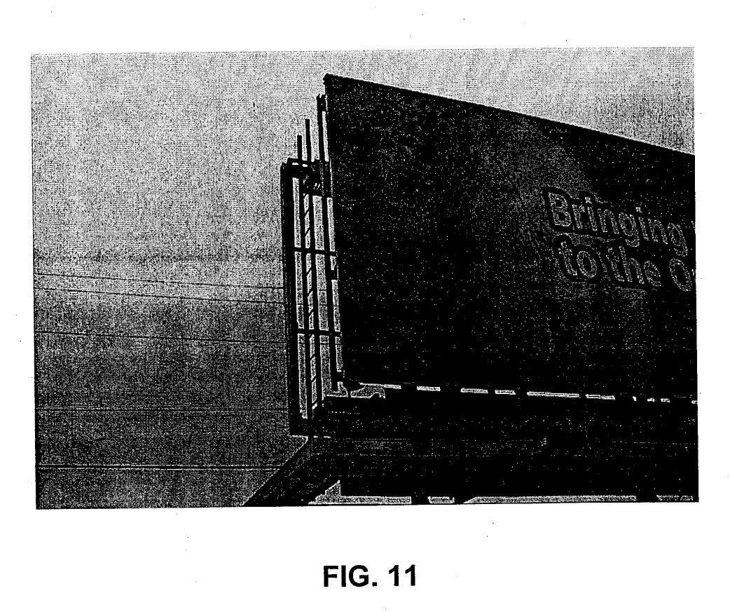

FIG. 11 illustrates a closer view of a winch tensioning device 28a, 28b in the alternative embodiment.

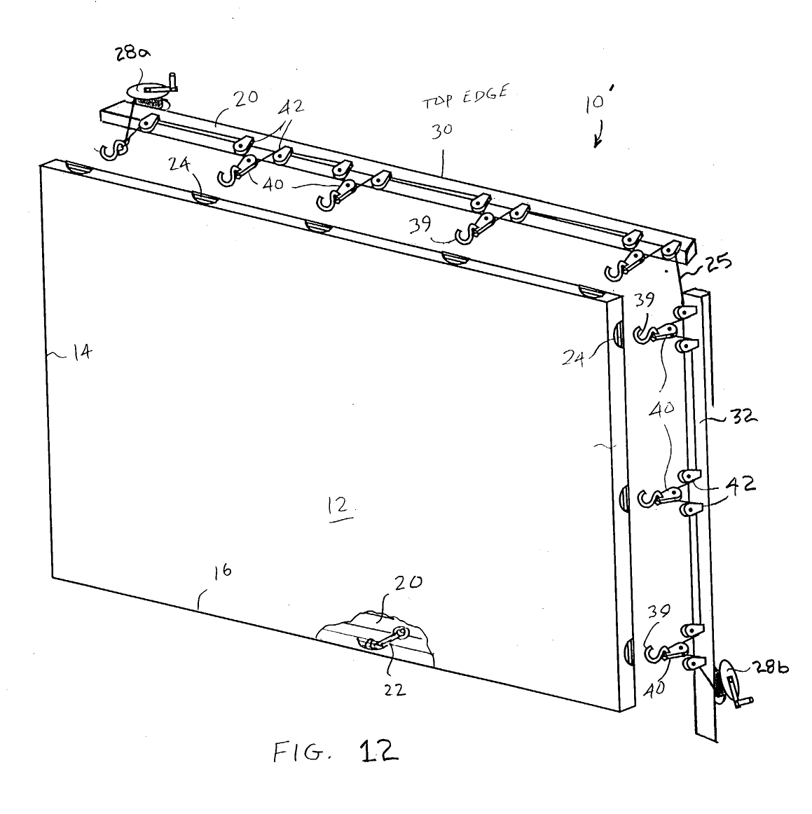

FIG. 12 illustrates the second and alternative embodiment of a tensioning system 10′ having multiple tensioning points. As in the first embodiment, the flexible vinyl sign 12 is affixed along one horizontal edge 14 to a sign frame 20, and along one vertical edge 16 to the sign frame. The edges 14, 16 are affixed to the frame by stationary hooks 22 that are engaged with rods 24 extending along the respective horizontal edge 14 and vertical edge 16 of the sign 12.

The alternative tensioning system 10′ preferably comprises a single elongate cable 25 that extends along the frame 20 from a first tensioning winch 28a at one end of the cable, along the top edge 30 of the frame, down a vertical edge 32 of the frame to a bottom point 34, to a second tensioning winch 28b at the other and opposite end of the cable 25, This arrangement may provide more even tensioning of the sign 12 when larger signs are employed.

In accordance with the foregoing, the present invention provides a tensioning system for signs that overcomes disadvantages of the prior art. In view of the foregoing description of the preferred embodiments of the invention, other embodiments will suggest themselves to those skilled in the art. Therefore, the scope of the present invention is to be limited only by the claims set forth below.

What is claimed is

1. A tensioning and attaching system for attaching a planar sheet to a frame, the frame having at least a first member, a second member, comprising:
at least one tensioning device attached to the frame;
a tensioning cable having a first end which is attached to a cable fixing point and a second end which is attached to the tensioning winch;
at least one first sheet connector attached to each of the tensioning cable, the planar sheet, and the first member;
at least one second sheet connector attached to each of the tensioning cable, the planar sheet, and the second member;
wherein the tensioning device applies a tension in the cable, and wherein the cable applies a tension in the planar sheet through the first sheet connector, and wherein the cable applies a tension in the planar sheet through the second sheet connector.

2. A tensioning and attaching system for attaching a planar sheet to a frame, the frame having at least a first member, a second member, comprising:
a tensioning cable having a first end and a second end,
a tensioning device affixed to the frame and connected to one end of the tensioning cable and a second tensioning device affixed to the frame and connected to the second end of the tensioning cable;
at least one first sheet connector attached to each of the tensioning cable, the planar sheet, and the first member;
at least one second sheet connector attached to each of the tensioning cable, the planar sheet, and the second member;
wherein the tensioning devices apply tension in the cable, and wherein the cable applies tension in the planar sheet through the first sheet connector, and wherein the cable applies a tension in the planar sheet through the second sheet connector.
